(19) United States
(12) Patent Application Publication
(10) Pub. No.: US 2022/0394005 A1
(43) Pub. Date: Dec. 8, 2022

(54) MESSAGING SYSTEM

(71) Applicant: Twitter, Inc., San Francisco, CA (US)

(72) Inventors: Abhijit C. MEHTA, San Francisco, CA (US); Stephanie GUEVARA, San Francisco, CA (US); Gloria LIU, San Francisco, CA (US); Alex JAFARI, San Francisco, CA (US); Sara BEYKPOUR, San Francisco, CA (US); Mateusz DZWONEK, San Francisco, CA (US); Mike JAODI, San Francisco, CA (US); David CARVER, San Francisco, CA (US); David CARR, San Francisco, CA (US); Smita Mittal GUPTA, San Francisco, CA (US); Miguel BOLLAR, San Francisco, CA (US)

(21) Appl. No.: 17/831,902

(22) Filed: Jun. 3, 2022

Related U.S. Application Data
(60) Provisional application No. 63/196,630, filed on Jun. 3, 2021.
(60) Provisional application No. 63/196,647, filed on Jun. 3, 2021.

(51) Int. Cl. H04L 51/21; H04L 51/42

(52) U.S. Cl. CPC H04L 51/21; H04L 51/42

(57) ABSTRACT

An example electronic device includes a display; a communication circuit; a memory storing one or instructions; and a processor for executing the one or more instructions to configure the processor to control the electronic device to: display, on the display, a message compose screen; receive message compose inputs to the message compose screen for composing a message; receive a message send input for sending the message via the communication circuit; set a timer; and send the message, via the communication circuit, after expiration of the timer.

### CROSS-REFERENCE TO RELATED APPLICATION(S)

This application claims priority to provisional U.S. Application No. 63/196,630, filed Jun. 3, 2021 and to provisional U.S. Application No. 63/196,647, filed Jun. 3, 2021, the contents of each of which are incorporated herein by reference in its entirety.

### BACKGROUND

### 1. Field

The disclosure relates to a messaging system such as a social networking system.

### 2. Description of Related Art

A user of a social networking system may sometimes desire to retract or undo the sending of the message. This desire can arise from noticing a typographical error(s) in the message content. A user may also desire to undo the sending of a message upon realizing that some content (e.g., an attachment) is not included or that some additional information or further explanation should be included in the message content (e.g., a further explanatory sentence). The user may realize a better way to express the thoughts in the message using different words. In other instances, the user may identify a factual error in the message or that some intended recipient is omitted and/or an unintended recipient is included. In still other instances, the user may simply regret sending a message because the message was sent, for example, in a moment of anger or impulse.

### SUMMARY

The systems and methods described herein allow a user to retract or “undo” the sending of a message within some period (e.g., up to 60 seconds) after initiating the sending of the message by, for example, selecting a “send message” button in a message compose screen, and before the posting of the message to the online social messaging platform for delivery to other users. In certain example embodiments, if the user decides (within the time window) to undo the message by selecting, for example, an Undo Send button, a message compose screen is opened, the user can review the content of the message and any media attached to the message, and the user can, for example, revise or edit the message, save the message as a draft, or delete the message.

### BRIEF DESCRIPTION OF THE DRAWINGS

The above and other aspects, features, and advantages of certain embodiments (i.e. examples) of the disclosure will be more apparent from the following description taken in conjunction with the accompanying drawings, in which:

FIG. 1 illustrates an example online social messaging platform 100.

FIG. 2 is a block diagram of an example user device 104 according to one or more aspects described herein.

FIG. 3 is a block diagram of an example platform server 110 according to one or more aspects described herein.

FIG. 4A illustrates an example message timeline.

FIG. 4B illustrates an example message compose screen.

FIGS. 5A, 5B, 5C-1, and 5C-2 show various entry points for an example Undo Send feature.

FIG. 6 is illustrates a non-limiting example of an Undo Send data flow in which the messaging platform performs certain operations.

FIG. 7 illustrates an example data flow for a case in which a message is still on the client when a user initiates an Undo Send process.

FIG. 8 is a sequence diagram for an example scenario in which the user posts an undoable message, and decides not to undo so that the message posts after the undo timer expires.

FIG. 9 is a sequence diagram for an example Undo Send scenario in which message validation fails.

FIG. 10 is a sequence diagram for an example Undo Send scenario in which the network connection between the client 801 and the server 803 is lost.

FIG. 11 is a sequence diagram for an example Undo Send scenario in which the network connection between the client 801 and the server 803 is lost before the message identifier is returned to the client 801.

FIG. 12 is a sequence diagram for an example Undo Send scenario in which a user successfully undoes sending of a message.

FIG. 13 is a sequence diagram for an example Undo Send scenario in which an undo send operation is unsuccessful because of a lost network connection.

FIG. 14 illustrates an example process flow in which, if a user undoes sending of a message, the message identifier gets added to the discard cache.

FIG. 15 illustrates an example process flow when the messaging application is in the background when the undo timer expires.

### DETAILED DESCRIPTION

Hereinafter, various embodiments (i.e. examples) of the disclosure may be described with reference to the accompanying drawings. Accordingly, those of ordinary skill in the art will recognize that modifications, equivalents, and/or alternatives on the various embodiments described herein can be variously made without departing from the scope and spirit of the disclosure. With regard to description of drawings, similar components may be marked by similar reference numerals.

In the disclosure, the expressions “have”, “may have”, “include” and “comprise”, or “may include” and “may comprise” indicate existence of corresponding features (e.g., components such as numeric values, functions, operations, or parts), but do not exclude presence of additional features.

In the disclosure, the expressions “A or B”, “at least one of A and/or B”, or “one or more of A and/or B”, and the like may include any and all combinations of one or more of the associated listed items. For example, the term “A or B”, “at least one of A and B”, or “at least one of A or B” may refer to all of a case (1) in which at least one A is included, a case (2) in which at least one B is included, or a case (3) in which both of at least one A and at least one B are included.

Terms such as “first”, “second”, and the like used in the disclosure may be used to refer to various components regardless of the order and/or the priority and to distinguish the relevant components from other components, but do not limit the components. For example, “a first user device” and “a second user device” can indicate different user devices regardless of the order or priority. For example, without departing the scope of the disclosure, a first component may be referred to as a second component, and similarly, a second component may be referred to as a first component.

It will be understood that when a component (e.g., a first component) is referred to as being “(operatively or communicatively) coupled with/to” or “connected to” another component (e.g., a second component), it may be directly coupled with/to or connected to the other component or an intervening component (e.g., a third component) may be present. In contrast, when a component (e.g., a first component) is referred to as being “directly coupled with/to” or “directly connected to” another component (e.g., a second component), it should be understood that there are no intervening components (e.g., a third component).

According to the situation, the expression “configured to” used in the disclosure may be used as, for example, the expression “suitable for”, “having the capacity to”, “designed to”, “adapted to”, “made to”, or “capable of”. The term “configured to” may not mean only “specifically designed to” in hardware. Instead, the expression “a device configured to” may mean that the device is “capable of” operating together with another device or other parts. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs or instructions which are stored in a memory device.

Terms used in the disclosure are used to describe specified embodiments and are not intended to limit the scope of the disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of the disclosure. In some cases, even if terms are terms which are defined in the disclosure, they may not be interpreted to exclude embodiments of the disclosure.

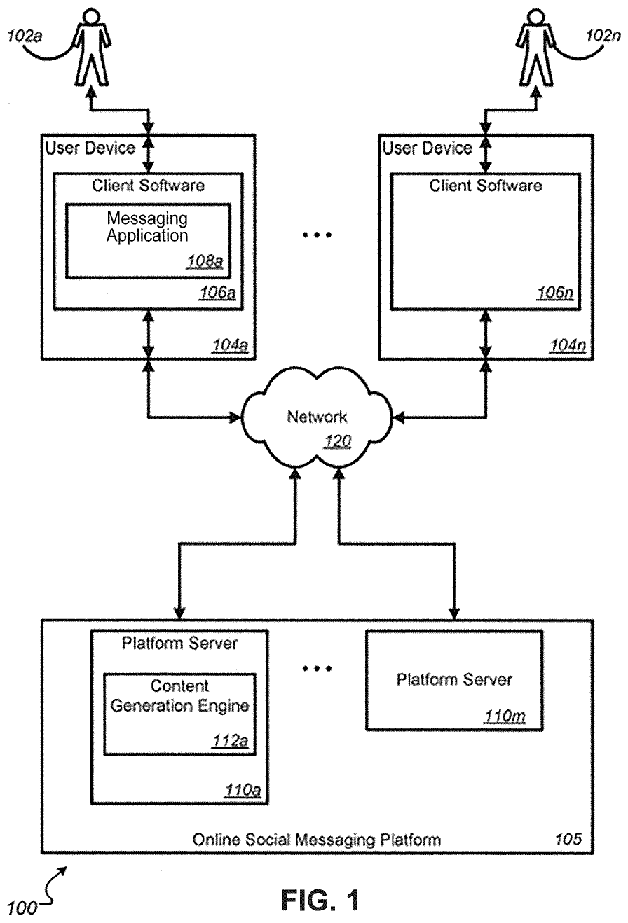

FIG. 1 illustrates an example system 100 including online social messaging platform 105 and example user devices 104a-104n configured to interact with the platform over one or more data communication networks 120 such as wide area networks, local area networks, the internet, telephone networks, mobile phone networks, and the like. The platform, the user devices, or both, are configured, as will be described, to implement or perform the various technologies described in this application including Undo Send operations.

The platform 105 is implemented on one or more platform servers 110a-110m. Each server is implemented on one or more computers, e.g., on a cluster of computers. Each server may include one or more modules or engines for performing operations such as message delivery and content generation (e.g., content generation engine 112a).

Users 102a-102n of the system use user devices 104a-104n, on which client software 106a-106n is installed, to use the system. Users can interact with the social messaging platform using the respective client software on their respective user devices. Among other things, the client software may include a messaging application 108a including, for example, a message compose feature for composing messages to be sent to other users and an Undo Send feature as described herein. The messaging application may also include features for displaying sent and received messages. The client software may include other applications.

A user may be an account holder of an account, or an authorized user of an account, on the messaging system. The messaging system may have millions of accounts of individuals, businesses, or other entities, e.g., pseudonym accounts, novelty accounts, and so on.

A user device 104 can be any Internet-connectable device, e.g., one or more of a laptop or desktop computer, a smartphone, a wearable device such as a smart watch, or an electronic tablet computer. The user device can be connected to the Internet through a mobile network, through an Internet service provider (ISP), or otherwise.

Each user device is configured with software, which will be referred to as a client or as client software 106a-106n, that in operation can access the messaging platform so that a user can post and receive messages, view and curate the user's message streams and message timelines, and view and interact with lists of content items. A timeline is a user interface presenting a stream of content items, e.g., messages, displayed in some order, e.g., an order in which the messages are posted or generated, with the most recent on top. As one of a user's timelines, a home timeline may be a user interface that the user sees by default and that presents a stream of content items selected for the user and generally updated in real-time, for example, content items from accounts the user has chosen to follow on the platform. As used herein, “timeline” is not limited to a strictly chronological ordering of messages and may, for example, be ordered based on time and/or relevance of messages to the interests of a particular user.

On any particular user device, the client may include a web browser or an HTML (hypertext markup language) document rendered by a web browser. The client may also include JavaScript code or Java code or the client may include dedicated software, e.g., an installed app or installed application designed to work specifically with the platform and/or a particular operating system (e.g., iOS or Android). The client may be or include a Short Messaging Service (SMS) interface, an instant messaging interface, an e-mail-based interface, or an API (application programming interface) function-based interface, for example.

The social messaging platform 105 is implemented on one or more computers in one or more locations that operate as one or more platform servers that support connections over wired or wireless networks 120 from many different kinds of user devices. The platform may have many millions of accounts, and anywhere from hundreds of thousands to millions of connections may be established or in use between clients and the platform at any given moment.

The platform facilitates real-time communication or near real-time communication. The platform and client software are configured to enable users to use the platform to post messages to the platform and to use the platform to receive messages posted by other users.

In some implementations, the platform provides facilities for users to send messages directly to one or more other users of the platform, allowing the sender and recipient(s) to maintain a private exchange of messages.

The platform is configured to provide content, generally messages, to a user in a message stream or timeline. The messages will generally be messages from accounts or topics the user is following, meaning that the recipient has registered to receive messages posted by the followed account or related to a followed topic, and optionally content that such accounts have engaged with, e.g., endorsed.

Optionally, the platform is configured to include in a recipient user's home timeline messages that the platform determines are likely to be of interest to the recipient, e.g., messages on topics of particular current interest, as represented by the number of messages posted on the topics by platform users, or messages posted on the topics of apparent interest to the recipient, as represented by messages the recipient has posted or engaged with, as well as selected advertisements, public service announcements, promoted content, polls, or the like.

The messaging platform is configured to enable users to exchange messages in real-time, e.g., with a minimal delay. The platform is also configured to enable users to respond to messages posted earlier, on the order of hours or days or even longer. The messaging platform is configured to display posted messages to one or more other users within a short time frame so as to facilitate what can essentially be a live conversation between the users.

Thus, the basic messaging functionality of the messaging platform includes at least posting new messages, providing message streams on client request, managing accounts, managing connections between accounts, messages, and streams, and receiving engagement data from clients engaging with messages. The messaging platform also indexes content items and access data and can provide the indexed data to account holders.

In some implementations of the messaging platform, a message contains data representing content provided by the author of the message. The message may be a container data type storing the content data. The types of data that may be stored in a message include text, graphics, images, video, and/or computer code, e.g., uniform resource locators (URLs), for example. Messages can also include key words or phrases, e.g., hashtags, that can aid in categorizing or relating messages to topics. Messages can also include metadata that may or may not be editable by the composing account holder, depending on the implementation. Examples of message metadata include a time and date of authorship and a geographical location of the user device when the user device sends the message. In some example embodiments, the metadata that is provided to the platform by a client is determined at least in part by privacy settings controlled by the user or the account holder.

Messages composed by one account holder may reference other accounts, other messages, or both. For example, a message may be composed in reply to another message composed by another account. A message may also be composed by a user in reply to a message originally posted by the user. Messages may also be re-publications of a message composed by and received from another account. Generally, an account referenced in a message may appear as visible content in the message, e.g., the name of the account, and may also appear as metadata in the message. As a result, the referenced accounts can be interactive in the platform. For example, users may interact with account names that appear in their message stream to navigate to the message streams of those accounts. The platform also allows messages to be private; a private message will only appear in the message streams of the composing and recipient accounts.

In some implementations, messages are microblog posts, which differ from e-mail messages, for example, in that an author of a microblog post does not necessarily need to specify, or even know, who the recipients of the message will be.

A stream is a stream of messages on the platform that meet one or more stream criteria. A stream can be defined by the stream criteria to include messages posted by one or more accounts. For example, the contents of a stream for a requesting account holder may include one or more of (i) messages composed by that account holder, (ii) messages composed by the other accounts that the requesting account holder follows, (iii) messages authored by other accounts that reference the requesting account holder, or (iv) messages sponsored by third parties for inclusion in the requesting account holder's message stream. The messages of a stream may be ordered chronologically by time and date of authorship, or reverse chronologically. Streams may also be ordered in other ways, e.g., according to a computationally predicted relevance to the account holder, or according to some combination of time and relevance score.

A stream may potentially include a large number of messages. For both processing efficiency and the requesting account holder's viewing convenience, the platform generally identifies a subset of messages meeting the stream criteria to send to a requesting client once the stream is generated. The remainder of the messages in the stream are maintained in a stream repository and can be accessed upon client request.

Accounts will in general have relationships with other accounts on the platform. Relationships between accounts of the platform are represented by connection data maintained by the platform, e.g., in the form of data representing one or more connection graphs. The connection data may be maintained in a connection repository. A connection graph includes nodes representing accounts of the platform and edges connecting the nodes according to the respective relationships between the entities represented by the nodes. A relationship may be any kind of association between accounts, e.g., a following, friending, subscribing, tracking, liking, tagging, or other relationship. The edges of the connection graph may be directed or undirected based on the type of relationship.

In some example embodiments, the platform tracks engagement with messages. For example, the platform may maintain, in a message repository, data that describes each message as well as the engagement with each message.

Engagement data can include any type of information describing user activity related to a message by an engaging account of the platform. Examples of engagement by a user include, for example, reposting the message, marking the message to indicate is a favorite of, liked by, or endorsed by the user, responding to the message, and mentioning or referencing the message. Engagement data may also include how many followers, connections, and/or friends of the context account have connections with the engaging account, e.g., are in a connection graph of the engaging account, or an indication that the context account is a favorite account of the engaging account.

Engagement data can also include any type of information describing activity related to a context account by an engaging account of the platform. A context account is any account that a user, i.e., the engaging account, is engaging with. Engagement data relating to a context account can be data about engagement activity of that account or engagement activity by others with that account.

The servers of the platform perform a number of different services that may be implemented by software installed and running on the servers. The services may be described as being performed by software modules. In some cases, particular servers may be dedicated to performing one or a few particular services and only have installed those components of the software modules needed for the particular services. Some modules will generally be installed on most or all of the non-special-purpose servers of the platform. The software of each module may be implemented in any convenient form, and parts of a module may be distributed across multiple computers so that the operations of the module are performed by multiple computers running software performing the operations in cooperation with each other. In some implementations, some of the operations of a module are performed by special-purpose hardware.

In some implementations, the platform includes numerous different but functionally equivalent front end servers, which are dedicated to managing network connections with remote clients.

The front end servers provide a variety of interfaces for interacting with different types of clients. For example, when a web browser accesses the platform, a web interface module in the front end module provides the client access. Similarly, when a client calls an API made available by the platform for such a purpose, an API interface provides the client access.

The front end servers are configured to communicate with other servers of the platform, which carry out the bulk of the computational processing performed by the platform as a whole.

A routing module stores newly composed messages in a message repository. The routing module also stores an identifier for each message. The identifier is used to identify a message that is to be included in a stream. This allows the message to be stored only once and accessed for a variety of different streams without needing to store more than one copy of the message.

A graph module manages connections between accounts. Connections determine which streams include messages from which accounts. In some implementations, the platform uses unidirectional connections between accounts and streams to allow account holders to subscribe to the message streams of other accounts. A unidirectional connection does not necessarily imply any sort of reciprocal relationship. An account holder who establishes a unidirectional connection to receive another account's message stream may be referred to as a “follower,” and the act of creating the unidirectional connection is referred to as “following” another account.

The graph module receives client requests to create and delete unidirectional connections between accounts. In some implementations, these connections are stored in a relationship repository as part of a unidirectional connection graph. Each connection in the connection graph repository references an account in the account repository or a stream in the stream repository.

In the same or a different embodiment, the graph module can provide and manage bidirectional connections. In a bidirectional connection, both accounts are considered subscribed to each other's account message streams. The graph module stores bidirectional connections in the relationship repository. In some implementations, the platform and connection graph repository include both unidirectional and bidirectional connections.

A delivery module constructs message streams and provides them to requesting clients, for example, through a front end server. Responding to a request for a stream, the delivery module either constructs the stream in real time, or accesses from a stream repository some or all of a stream that has already been generated. The delivery module stores generated streams in the stream repository. An account holder may request any of their own streams, or the streams of any other account that they are permitted to access based on security settings. If a stream includes a large number of messages, the delivery module generally may identify a subset of the messages to send to a requesting client, in which case the remainder of the messages are maintained in a stream repository and sent upon client request.

An account module enable account holders to manage their platform accounts. The account module allows an account holder to manage privacy and security settings, and their connections to other account holders. The account module may store information about users of the platform including, but not limited to, an account name, which is not necessarily a real name, an identifier, a user name, a picture, a brief description of themselves or the entity, an e-mail address, and/or a website. Information about each account is stored in an account repository.

Client software allows account holders receiving a stream to engage, e.g., interact with, comment on, or repost, the messages in the stream. An engagement module receives these engagements and stores them in an engagement repository. Types of engagement include selecting a message for more information regarding the message, selecting a URI (universal resource identifier) or hashtag in a message, reposting the message, or making a message a favorite. Other example engagements types include opening a “card” attached to message, which presents additional content that is a target of a link in the message, or links to an application installed on the user device. Account holders may engage further with the additional content, e.g., by playing a video or audio file or by voting in a poll.

In addition to recording active interactions with messages through explicitly received user device input, the engagement module may also record passive interactions with messages. An impression occurs when a client presents the content of a message on a user device. Impression engagements include the mere fact that an impression occurred, as well as other information, e.g., whether a message in a stream appeared on a display of the user device, and how long the message appeared on the display. Any engagement stored in the engagement repository may reference the messages, accounts, and/or stream involved in the engagement.

Engagements may also be categorized beyond their type. Example categories include engagements expressing a positive sentiment about a message (“positive engagements”), engagements expressing a negative sentiment about a message (“negative engagements”), engagements that allow an advertiser account to receive monetary compensation (“monetizable engagements”), engagements that are expected to result in additional future engagements (“performance engagements”), or connection engagements that are likely to result in one account holder following another account (“connection engagements”). The negative engagements category includes, for example, engagements dismissing a message or reporting a message as offensive while the positive engagements category typically includes engagements not in the negative engagements category. Example performance engagements include selecting a URL (uniform resource locator) in a message or expanding a card. Example monetizable engagements include, for example, engagements that result in an eventual purchase or a software application install on a user device. Generally, categories and types are not coextensive; a given type of engagement may fall into more than one category and vice versa.

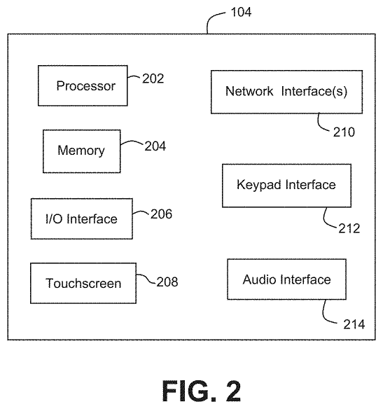

FIG. 2 illustrates an example user device 104 according to one or more aspects described herein. User device 104 may include one or more hardware and/or software components, such as processor 202, memory 204, input/output (I/O) interface 206, touch sensitive display (touchscreen) 208, network interface(s) 210, keypad interface 212, and audio interface 214. Some or all of these components may be communicatively linked by a system bus, network, or other connection mechanisms.

By including one or more of these and/or other components, user device 104 may be implemented as a desktop computer, laptop computer, server, tablet computer, netbook, cellular phone, mobile computing device, wearable device, and/or the like. In at least one arrangement, user device 104 may include a plurality of one or more of the components described herein. For instance, in at least one arrangement, user device 104 may include two or more processors (e.g., a main processor and an auxiliary processor such as a graphics processor (GPU)).

In one or more arrangements, processor 202 may execute computer-executable and/or computer-readable programs and instructions stored in memory 204. For example, processor 202 may execute one or more instructions that cause one or more of the methods described herein to be performed or otherwise implemented by user device 104. Additionally or alternatively, processor 202 may execute instructions that cause one or more user interfaces (e.g., a message composer) described herein to be displayed on a display included in user device 104, such as touchscreen 208.

In one or more arrangements, touchscreen 208 may comprise an electronic visual display (e.g., a liquid crystal display (“LCD”) screen, a plasma display panel (“PDP”), a cathode ray tube (“CRT”) display, a light emitting diode (“LED”) display, and/or an organic light emitting diode (“OLED”) display). Touchscreen 208 may respond to touch-based user input and thus may function as a “touchscreen” display. Touchscreen may implement one or more touch sensing technologies (e.g., resistive, surface acoustic wave, capacitive, strain gauge, optical imaging, dispersive signal technology, acoustic pulse recognition, coded LCD, etc.).

In one or more arrangements, input/output (I/O) interface 206 may include one or more adapters, connection ports, and other components via which user device 104 may provide input and output. For example, I/O interface 206 may include one or more adapters for outputting data to and/or receiving data from a display (e.g., for providing audiovisual, graphical, and/or textual output), keypad, microphone, mouse, optical reader, scanner, speaker (e.g., for providing audio output), stylus, touch screen, and/or other component. I/O interface 206 further may include one or more of a USB port, a serial port, a parallel port, an IEEE 1394/Firewire port, an APPLE iPod Dock port, and/or other ports.

In one or more arrangements, network interface(s) 210 may establish and/or provide network connectivity to a network(s) (e.g., a local area network, a wide area network, such as the Internet, etc.). Network interface 210 thus may include hardware and/or software components for communicating via Ethernet, TCP/IP, FTP, HTTP, HTTPS, and/or other protocols. The network interface(s) 210 may additionally or alternatively establish and/or provide network connectivity to a wireless network (e.g., a local area network, a wide area network, such as the Internet, a cellular voice and/or data network, etc.). Network interface(s) 212 thus may include hardware and/or software components for communicating via Ethernet, TCP/IP, FTP, HTTP, HTTPS, IEEE 802.11b/g/a/n, Bluetooth, CDMA, TDMA, GSM, Near Field Communication (NFC), and/or other protocols.

In one or more arrangements, keypad interface 212 may include one or more physical keys, buttons, and/or switches that may be operated to provide input to and/or control various aspects of user device 104. Audio interface 214 may include one or more speakers, audio ports (e.g., a headphone jack), microphones, and/or other audio components. Audio interface 214 may allow user device 104 to provide audio feedback, receive audio input (e.g., sound input, speech commands, etc.), and/or provide telephone functionalities.

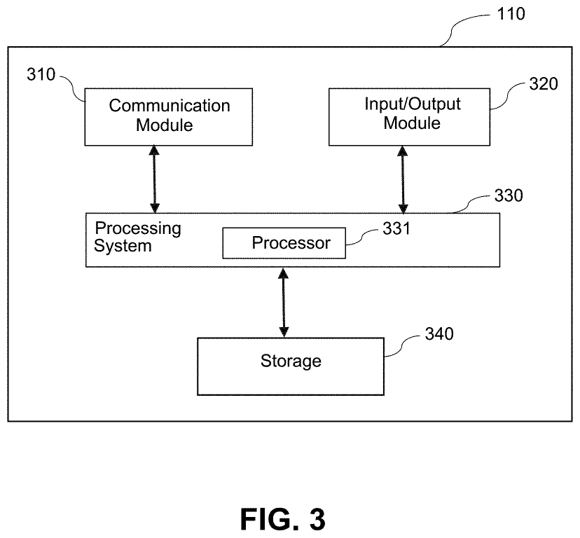

FIG. 3 illustrates a non-limiting, example block diagram for an example platform server 110. In this example embodiment, the server 110 includes a communication module 310 including communication circuitry and circuitry (e.g., a transceiver), an input/output module 320 including I/O circuits and circuitry, a processing system 330 including a processor(s) 331, and a storage 340, all of which may be communicatively linked by a system bus, network, or other connection mechanisms.

The communication module 310 functions to allow the server 110 to communicate with one or more of other devices (e.g., user devices 104, other platform servers 110 or a global server). The communication module 310 is configured to transmit data to other devices and/or receive data from other devices.

In certain example embodiments, the communication module 310 may comprise one or more communication interfaces supporting satellite communications, radio communications, telephone communications, cellular communications, internet communications, and/or the like. In other example embodiments, the communication module 310 may comprise a wireless transceiver with connected antenna, a wireless LAN module, a radio-frequency (RF), Infrared, or Bluetooth® transceiver, and/or a near field communication transceiver module. One or more of these communication components may collectively provide a communication mechanism by which the server 110 can communicate with other devices, platforms and/or networks.

The data storage 340 may comprise one or more volatile and/or non-volatile storage components, such as, a hard disk, a magnetic disk, an optical disk, magneto-optical storage, read only memory (ROM) and/or random access memory (RAM), and may include removable and/or non-removable components. The data storage 340 may be integrated in whole or in part with the processing system 330.

The processing system 330 may comprise one or more processors 331, including one or more general purpose processors and/or one or more special purpose processors (i.e., DSPs, GPUs, FPs or ASICs). The processing system 330 may be capable of executing application program instructions (e.g., compiled or non-compiled program and/or machine code) stored in data storage 340 to perform functions and processes described herein. The data storage 340 may include a non-transitory computer-readable medium, having stored thereon one or more programs and/or program instructions that, when executed by the processing system 330, cause the server 110 to perform processes or functions disclosed herein and/or illustrated by the accompanying drawings.

In certain example embodiments, the programs and/or program instructions stored in the storage 340 may include an operating system program and one or more programs, such as program instructions for load balancers and the message-related features described herein.

The input/output module 320 of the server 110 may enable the server 110 to interact with a human or non-human user, such as to receive input from a user and to provide output to the user. The input/output module 320 may include a touch-sensitive or presence-sensitive panel, keypad, keyboard, trackball, joystick, microphone, still camera and/or video camera, and the like. The input/output module 320 may also include one or more output components such as a display device, which may be combined with a touch-sensitive or presence-sensitive panel. In an example embodiment, the input/output module 320 may display various user interfaces to enable a user or an operator to access services or functions provided by the server 110.

As noted above, aspects of the technology described herein can be implemented, for example, by a messaging application running on an electronic device or using a web browser running on the electronic device. The following, non-limiting example embodiments will be described with reference to a messaging application running on an electronic device such as a smart phone or a computer such as a personal computer or tablet computer, but it will be readily recognized that the technology is not limited in this respect.

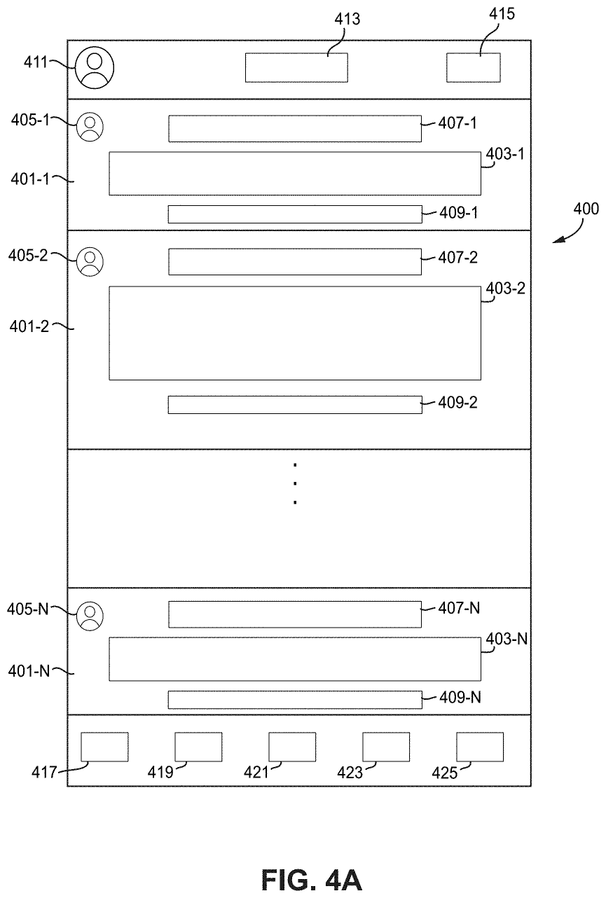

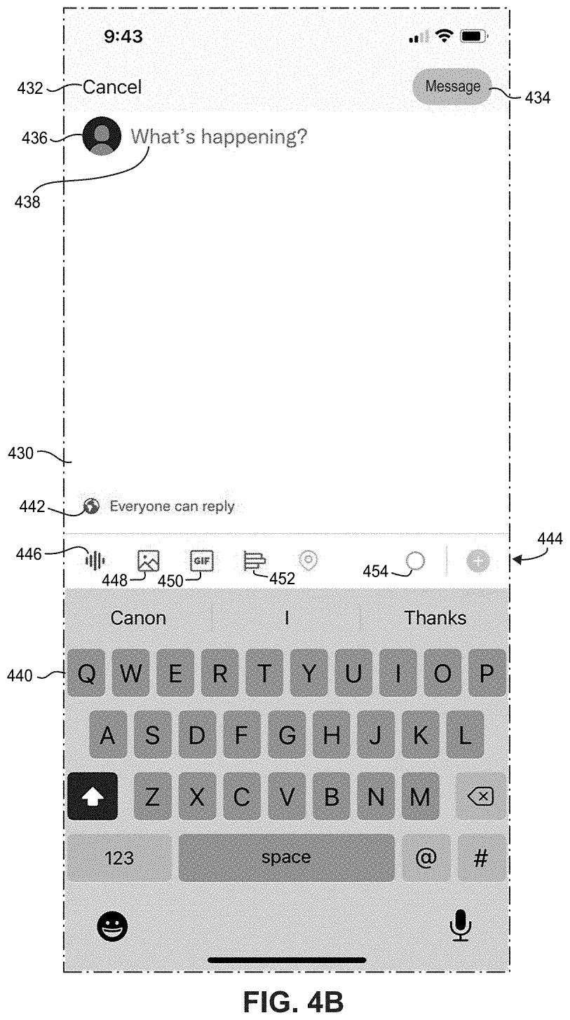

FIG. 4A shows an example message timeline 400. As noted above, a timeline is a user interface presenting a stream of content items, e.g., messages, displayed in some order, e.g., an order in which the messages are posted or generated, with the most recent on top. As one of a user's timelines, a home timeline may be a user interface that the user sees by default and that presents a stream of content items selected for the user and generally updated in real-time, for example, content items from accounts the user has chosen to follow on the platform. Other timelines may be associated with a user's profile and include a Messages timeline including, for example, messages composed by a user and a Messages and Replies timeline showing, for example, both a user's replies to messages and the messages to which the replies are associated. Other timelines may also be presented. As noted, “timeline” is not limited to a strictly chronological ordering of messages and a timeline may, for example, be ordered based on time and relevance of messages to the interests of a particular user.

Timeline 400 includes messages 401-1, 401-2, . . . 401-N. Each message may include message content 403, where the content may include one or more of text, images, graphics, video, multimedia content, URLs, and/or the like. Information about the message and the sender of the message may be positioned above the message content. For example, an image 405 associated with the sender may be provided and text 407 may identify a name of the sender, an address of the sender, and/or date/time information reflecting the sending of the message. Other information may also be provided. An action bar 409 below the message content contains one or more icons for allowing a user to engage with a message by replying to the message, forwarding the message, liking the message or sharing the message outside the messaging system (e.g., by text or email).

At the top of the timeline 400, an image 411 associated with the user may be provided, along with other icons or graphics 413 and 415. These icons or graphics may, for example, be used to change an order of the messages in the timeline from a chronological order to an order based on a user's interests.

At the bottom of the timeline, icons or graphics 417, 419, 421, 423, and 425 may be provided for further user actions. Selection of these icons or graphics may, for example, allow a user to return to a home timeline, conduct a search, send a direct message to a particular recipient, access notifications, access a message compose screen, or the like.

Of course, messages may be displayed in a variety of different manners and the timeline of FIG. 4A is provided by way of example, not limitation.

FIG. 4B shows a message compose screen 430. At the top of the message compose screen 430, a cancel button 432 for canceling the message compose operation and a send message button 434 may be provided. An image or graphic 436 representing the user (e.g., a picture) may be positioned adjacent a text entry field 438 into which text may be entered using a keyboard 440. A graphic 442 may be selected to identify who can respond to the message being composed (e.g., everyone, people followed by the user, or people mentioned in the message). A set of icons 444 above the keyboard 440 includes an icon 446 for allowing voice input, an icon 448 for allowing attachment of a photo, an icon 450 for allowing attachment of an graphic or animation (GIF), an icon 452 for allowing a user to generate a poll, and a progress icon 454 showing how many characters remain if the message content is limited to some maximum number of characters.

Here again, the compose message screen of FIG. 4B is provided by way of example, not limitation.

When using the above-described social messaging platform, a user may sometimes desire to retract or undo the sending of a composed message. This desire can arise from noticing a typographical error(s) in the message content. A user may also desire to undo sending of a message upon realizing that some content (e.g., an attachment) is not included or that some additional information or further explanation should be included in the message content (e.g., a further explanatory sentence). The user may realize a better way to express the thoughts in the message using different words. In other instances, the user may identify a factual error in the message or that some intended recipient is omitted or an unintended recipient included. In still other instances, the user may simply regret sending message due to, for example, a moment of anger or impulse.

According to the systems and methods described herein, upon sending an original message (or a reply to a message), a user is given an option to “undo” the sending of the message. For example and without limitation, this could be in the form of a “Message Sent” toast with an “edit” button (if the message is sent from outside a user's home timeline) or a message preview with a composable view that contains an “edit” button on it (if the message is sent from any “surface” with a timeline (e.g., home timeline, profile timeline(s), and the like)). The Undo Send view persists for some user-configurable period of time (e.g., 30 or 60 seconds, which can be modified by the user in feature settings). While the message is in an “editable” state, the client holds the draft of the message locally.

In another example embodiment, the messaging platform may be configured to support the client by providing a backing store for the editable message so that, if, for example, the user closes out of the messaging application or some other event triggers the messaging application to become inactive, the message is sent out at the expiration of the period of time. Should the user undo the sending of the message, the user returns to the full compose view where the message composer is populated with the editable message and the user may make changes.

Thus, the systems and methods described herein allow a user 102 to retract or “undo” the sending of a message by a user device 104 within some period (e.g., up to 60 seconds) after initiating the sending of the message by, for example, selecting a “send message” button in a message compose screen (e.g., send message button 434 in message compose screen 430), and before the posting of the message to the online social messaging platform 105 for delivery to other users. In short, the systems and methods described herein provide a tool by which a user can “undo” (or recall) a “sent” message for further editing because of spelling mistakes, grammatical errors, other typographical faults, or any other reason. The “Undo Send” feature described herein allows users a short time window to retrieve and review a message after the “Send Message” button is selected, but before the message is available to other users (e.g., recipients). In certain example embodiments, if the user decides (within the time window) to undo the sending of a message by selecting an Undo Send button, the message compose screen is re-opened and the user can see the text and any media attached to the message whose sending has been undone. The user can then, for example, revise or edit the message, save the message as a draft, or delete the message.

The “Undo Send” feature can be provided in various manners. As noted, in some example embodiments, a “Message Sent” toast with an “edit” button can be provided on the user interface. Alternatively, if message composing is initiated while the user is viewing a timeline of messages, the composed message after the message send button is selected can be provided as a preview message within the timeline and the preview message can include an edit or an undo button. The edit or undo button view on the preview message persists for a configurable period of time (e.g., up to 60 seconds), which period of time is configurable by the user (e.g., by user settings), and the time period may be timed using a software timer or a hardware timer. While the message is in an editable state (or is “undoable”), a draft of the message can be stored locally in memory of the user device.

Should the user provide input to the edit button (e.g., via a tap or other interaction) from an undo send entry point (e.g., a toast or preview message), the user can return to a full compose view where the message compose screen of the client software is pre-populated with the message for which sending has been undone, which is in an editable format so the user may make changes. The user may then make any desired changes to the message, save the message as a draft, or delete the message.

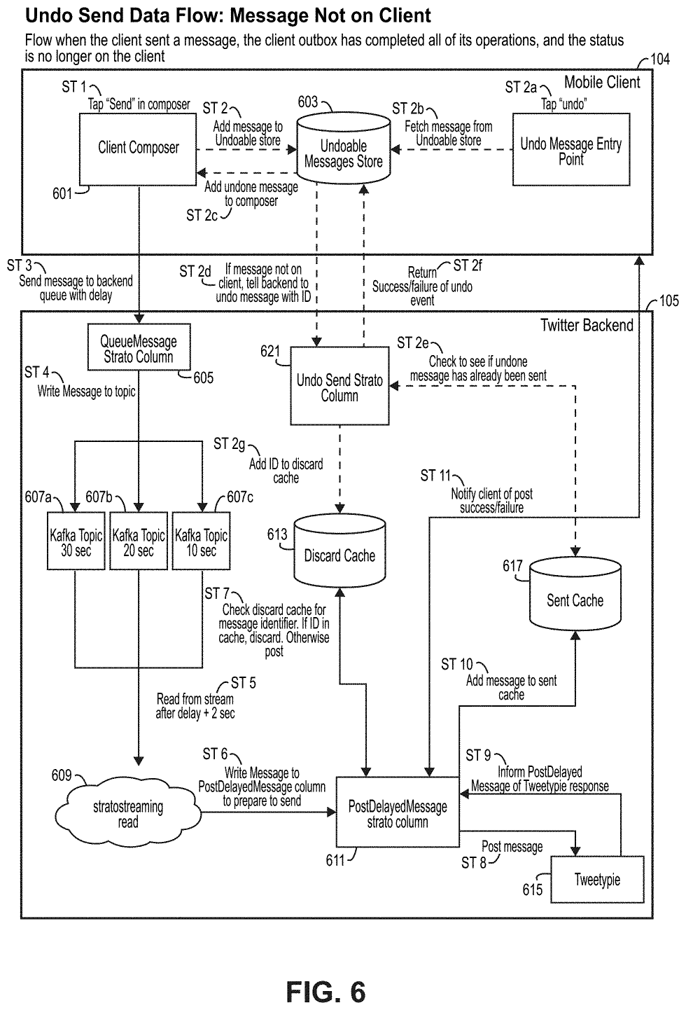

In some example embodiments described herein (see, e.g., FIG. 6), on-line social messaging platform 105 can support the user by providing a backing store for the undoable message so that, in a case in which the user closes out of the client software, or some other event triggers the client software to become inactive, the message may be sent out upon expiration of the undo time period.

The functionality of the Undo Send feature described herein can be included as a basic feature of client software 106 or can be an additional feature (or one of a bundle of additional features) included in a larger subscription product, e.g., a product for power users of the platform and/or a product requiring payment.

In some non-limiting example embodiments, a user may be provided with the capability of undoing the sending of a message composed and sent from first client software using second (different) client software. For example, a user may compose and select to send a message from first client software 106 executing on a first user device 104 (e.g., a mobile telephone of the user) and undo the message using second client software 106 executing on a second user device 106 (e.g., a personal computer of the user).

The messaging system 100 may track metrics relating to use of the Undo Send feature by a user. For example, the system 100 may track how frequently users (individually or collectively) use the Undo Send feature, as well as how many users disable the Undo Send (e.g., via user settings) before or after using the feature. Other metrics relating to the Undo Send feature may be tracked or monitored and the systems and methods described herein are not limited in this respect.

The providing of a timer for undoing the sending of a message results in various states of system 100, e.g., based on whether the timer has elapsed or not. Some examples of these system states are discussed below.

Client Software Active when Undoable Timer Elapses

As discussed above, example embodiments of the Undo Send feature include an ability to reproduce the message the user wants to edit in the message compose screen of the client software when “undo” or “edit” (or some other input) is selected to initiate the Undo Send process. The types of messages that might need to be reproduced include, but are not limited to, messages with media (e.g., photos, videos, gifs), voice messages, and polls. In order to facilitate this reproduction, a local copy can be saved (for the undo time period) of any original message, or a reply to a received message, sent by a user for whom the Undo Send feature is accessible (e.g., the user has a valid subscription to a product with the Undo Send feature) and who has the Undo Send feature enabled for the type of message the user is sending (original message and/or reply message).

In an example embodiment, this local copy can supplement a draft and outbox infrastructure in the memory 204 of the user device by adding an “Undoable” directory. When an undoable message is sent from the message compose screen, rather than going directly into the outbox, the message may be held in an undoable message directory throughout the duration of the undo time period. Upon timer expiration, the message may be moved into the outbox for sending to the messaging platform 105.

In some cases, with regard to large pieces of media or messaging when there is poor connection between client and server, upload to the messaging platform 105 may not begin until after the timer has completed. In this case, an undoable message could be placed immediately in the outbox and an outbox operation can be provided that waits to send the undoable message, but allows the media upload operation to begin upload before the timer completes.

Client Software Backgrounded, Returns with Time Left on Undoable Timer

In a case in which a user backgrounds the messaging application and returns with undo timer still running, the timer will show the remaining time and the Undo Send option will still be available.

Application Backgrounded when Timer Elapses

The undo timer can elapse while the messaging application is backgrounded. In order to attempt to send messages while the application is backgrounded, a background task can be created, if needed, when a message is registered to an undo send process.

Background tasks may not be very long running and it is possible that, in a case in which a user is trying to upload a large message or if the user has poor connectivity to the server, the background task may not be able to be completed. In this case, the undoable message can be stored as a draft. If the user returns to the application within some period of time (e.g., one hour), an attempt to send the message can again be made. If the user returns after the period of time, the message can be saved as a draft and the user can be notified that the message has been saved as a draft.

Application Closed while Timer Running

In a case in which a user closes the messaging application while the undoable timer is running, the user cannot be alerted that the message will not be sent. In this case, the undoable message may be stored as a draft and the same logic as for the situation mentioned above in which the application is backgrounded is performed, i.e., if the user returns to the app within (for example) a one hour time period, an attempt is made to send the message again and, if the user returns after the one hour time period, the message is saved as a draft and the user is notified that the message has been saved.

Account Logged Out of while Timer Running

In a case in which a user logs out (different from switching accounts) while the undo timer is running, the user may be alerted that logging out will result in the message being discarded and the user may be given an option to either remain logged in or continue with the log out process. Some example embodiments can be configured so that the message is not saved to drafts if the user logs out.

Account Switched while Timer Running

In a case in which the user switches accounts while an undoable message timer is running, the message is sent as expected.

### Undo Timer

In example embodiments, tracking when a message should be sent can be performed in various ways. For example, a key value pairing of a message to its respective timer can be used. In some example embodiments, multiple messages (e.g., a grouping of related messages or a so-called “tweetstorm”) can be stored with the same timer, although the technology described herein is not limited in this respect. All messages in the grouping can have the same send date information and undo time interval. Thus, for example, the undo timer from a first message in the grouping of related messages may be used in connection with the Undo Send feature for these grouped messages.

The Undo Send timer may be started when an operation for sending a message (e.g., interacting with (e.g., tapping) a send button such as button 434 in FIG. 4B) is initiated (e.g., when a user selects to send a message). In some example embodiments, if a user backgrounds or closes the messaging application and returns, the timer may be deallocated. In this case, various message properties may be stored and these properties can be used to recreate the timer, if necessary. For example, an “undoableAdded” property can be set when a message is added to the undoable directory. An “undoTimeInterval” property can be taken from an interval configured by the user (e.g., via a settings menu) for undoing the message and added to the message. An “undoableSendDate” property is a derived property that can be calculated using an “undoableAddedDate” property (which indicates when the message was added to the undoable directory) and the “undoTimeInterval” property.

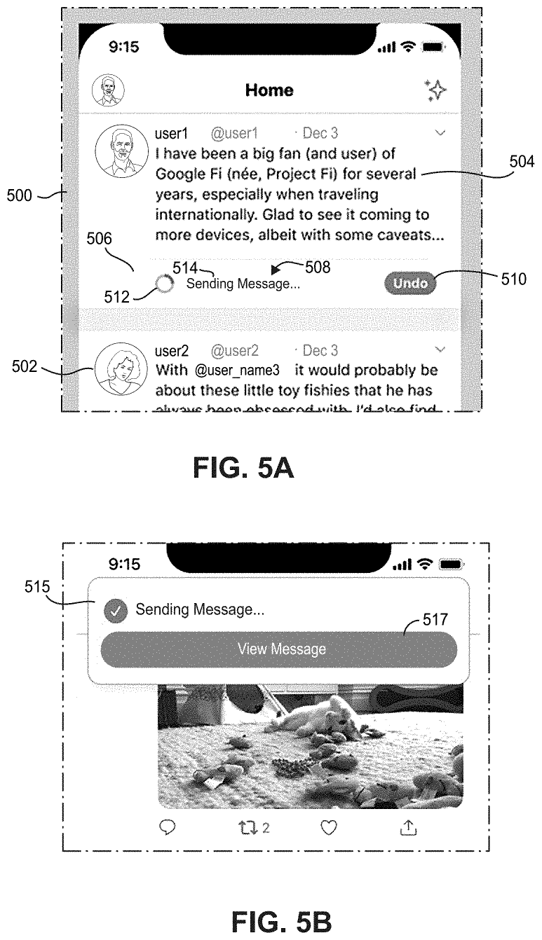

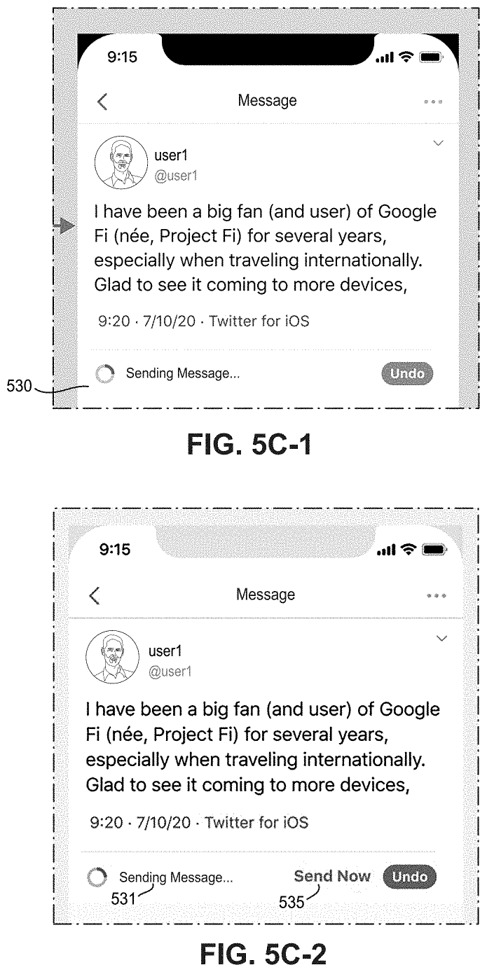

FIGS. 5A-5C show various entry points for an example Undo Send feature.

With reference to FIG. 5A, in a case in which a user composes a message from the user's home time line 500 including one or more displayed messages 502, the user will see an undoable message preview 504 at the top of their timeline 500. The message preview 504 includes a status bar 506 including sending message status information 508 and an Undo button 510. The sending message status information 508 includes a timer progress icon 512 and text (e.g., “Sending Message”) 514. The text 514 provides an explanation that the send process for the message has been initiated and the timer progress icon 512 shows the progress of the Undo timer to provide an intuitive visual indicator of the time remaining before the Undo timer expires and the message is actually sent. Generally speaking, the message status information may include any one or more of text, graphics, icon(s), image(s), and the like. To initiate the Undo Send process, the user may interact with (e.g., tap) the Undo button 510.

To produce the “Undo Send” view in the home timeline 500, the messaging application can, for example, determine that the Undo Send feature is accessible to the user (e.g., the user is a subscriber to the feature) and that the Undo Send functionality is enabled via user settings for the type of message being sent (e.g., original message, reply message). The message selected to be sent can then be “injected” into a timeline downloaded from platform 105.

Throughout the duration of the undo time period, the message preview 504 can appear on the home timeline 500. In one example embodiment, the message preview 504 is initially presented and remains at the top of the home timeline. In another example embodiment, the message preview 504 can be pushed down in the timeline 500 if the user, for example, refreshes the timeline view or can be pushed down or removed from the timeline 500 if the user does not refresh the timeline for some time period after selecting to send the undoable message 504.

As noted above, a user timeline is generally obtained from the messaging platform. In an embodiment in which the undoable message is maintained locally on the user device during the undoable time period, the messaging application may be configured to “manually” or locally inject the undoable message into the timeline.

With reference to FIG. 5B, an undoable “toast” 515 is another entry point for the undo send processing. Toast 515 is displayed after a user selects “send” on an undoable message. Toast 515 has at least one action—selecting the toast or the “View Message” button 517 takes the user to a Message Details preview of the undoable message. The Message Details view is one in which, for example, a single message and its related information is displayed.

The Message Detail undo entry point of FIG. 5C-1 or FIG. 5C-2 can be accessed by, for example, tapping on a status in preview state (e.g., a home timeline preview state) or anywhere on the toast entry point of FIG. 5B. In an example embodiment, one or the other of the FIG. 5C-1 view or the FIG. 5C-2 view can be shown when the undo timer is valid (e.g., not expired). If a user is in the Message Details views of FIG. 5C-1 or 5C-2 when the undo timer expires, the view can refresh, hiding the sending message information 530 (FIG. 5C-1) or 531 and 535 (FIG. 5C-2) and showing information such as the send timestamp and other message actions (e.g., reply, forward, like, etc.). In scenarios in which the message may still need upload time to the server after the message is moved to the outbox (e.g., message with large media or poor connection), the Undo Send view can remain, the text can be changed to “Message Sent”, the progress indicator will be completed, and the buttons will be hidden or deactivated.

The FIG. 5C-2 view differs from the FIG. 5C-1 view with respect to the Send Now text 535. If the FIG. 5C-2 is presented, the Send Now text 535, when selected, functions to immediately move the message to the outbox and disable all timers for that message. In the case of a group of messages or a “tweetstorm”, selecting the Send Now text 535 sends all messages in the group regardless of which send now text for the different messages in the group that is selected. In an example embodiment, the Send Now text is only provided in the Message Details view, and not in any other entry points, although the systems and methods described herein are not limited in this respect. When the Send Now text is selected, the user experiences the same UI as when a timer elapses—the Undo Send view is hidden and the page is refreshed with the sent message. In the situation in which the message needs time to upload, as noted above, the Undo Send view will remain until upload is complete, the text will change to “Message Sent”, the progress indicator will be completed and the buttons will be hidden to prevent a user from being able to tap multiple times.

Another entry point for the undo send process is a User Profile page. In an example embodiment, there are two places on the profile where an undoable message preview can be presented. First, on a Messages tab on the user profile and, second, on a Messages & Replies tab on the user profile. In each of these cases, an interface such as that shown in FIG. 5A may be provided for a message(s) for which the undo send process can be performed.

Injection of Undoable Message into Home Timeline

An outbox controller function can be called when the send button in a message composer screen is selected. However, in an example embodiment, in order to prevent the status from being sent immediately and causing the message to be sent, the message may be moved to an undoable repository rather than to the outbox. When the message is moved into the undoable directory, a notification is generated so that other functions (also referred to as listeners) can identify that an undoable message has been added. One such function or listener is the function responsible for injecting messages into timelines. In this way, a function responsible for injecting messages in to timelines can append the undoable message into, for example, a user's home timeline.

Injection of Undoable Messages into Profile Page

Other functions inject the status into the Message and Message & Reply timelines to inform these timelines that there is a message to be included in their respective timelines. When the respective timelines ultimately refresh with the sent message, the pending state gets removed from the timeline.

### Replies Entry Point

In the case that “Undo Send” is enabled for replies, the undoable reply can be injected into the Message Details views. After the status indicates the reply is successfully sent, the injection can be removed by refreshing the timeline and pulling down a new timeline that includes the sent undoable.

The Undo Send feature can be selectively provided (enabled/disabled) to users through feature gating tools in the framework of the messaging platform.

In example embodiments, the undo time can be determined based on the characteristics of the message. One such characteristic is the content of the message. For example, a first message containing the text “Thanks! Have a good day!” may be a less likely candidate to be undone than a second message including text related to some political or controversial topic. Consequently, the system may configure a shorter undo time (e.g., 10 seconds) than for the second message (e.g., 30 seconds). Another such characteristic (e.g., in the case of a direct message) is the recipient of the message. For example, a message to a friend contact may be a less likely candidate for being undone than a message to a business contact and thus the message to the friend contact may be configured with a shorter undo period than the message to the business contact. Yet another characteristic may be the time taken to compose the message.

The determining of the undo time based on message characteristics may use artificial intelligence model processing. An artificial intelligence model may be generated by machine learning. Such learning may be performed, e.g., by the electronic device where the artificial intelligence is performed or via a separate server. Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

As described herein, the features of Undo Send technology described herein may be implemented in various manners. By way of example and without limitation:
A user can send an “undoable” tweet while the messaging application is active with no involvement of messaging platform 105. In this case, when a user selects to send the message, a message draft is saved locally.
A user can configure (change) the time of their undo period through application settings (e.g., 5, 10, 15, 20, 25, 30, 35, 40, 45, 50, 55, or 60 seconds) accessed, for example, via a settings menu. The draft message will be sent to the messaging platform 105 after the timer has elapsed.
A user can selectively (e.g., via a settings menu) enable/disable the Undo Send features for, for example, original messages or replies to messages.
A user can enter the Undo Send flow through a home timeline entry point. When a user selects to send on a message composed from a home timeline, a message draft is saved locally. A preview of the message that was selected to send is injected into the home timeline. An undo view including, for example, a timer or timer progress indicator, text, and/or an Undo button is visible to the user on their message preview. Selecting the Undo button takes the user back to the message compose screen with the message populated in the compose screen.
A user is able to enter the Undo Send flow through a toast entry point. When a user selects the send message button for a message composed outside of the home timeline, a message draft is saved locally. Upon send, a toast with the option to undo appears. Tapping on the “Undo” button takes the user back to the message compose screen with the message populated in the compose screen. If Undo is not selected within the allocated time threshold, the message is sent.
A user is able to enter the Undo Send flow through a profile status entry point. When a user selects to send a message composed in the Profile page, a message draft is saved locally. A preview of the message selected to be sent is injected into the user profile “Messages” & “Messages & Replies” tab. An undo view including a timer or timer progress indicator, text, and/or an Undo button is visible to the user on their Message preview. Selecting the Undo button takes the user back to the message compose screen with the message populated in the compose screen.
A user is able to enter a Message Details view with undo treatment via Message preview tap or Toast tap. If the Undo Send timer expires while the user is in the Message Details view, the “Undo” view is hidden, inline actions appear, persistent compose appears. Any views not needed prior to sending out the message will reappear after send.
A user is able to enter Message Details with Undo treatment and see a Send Now button. The Send Now option may be visible only in Message Details. Send Now may be gated by a client feature switch.

In example embodiments described above, social messaging platform 105 need not perform operations for implementing the Undo Send feature. In other example embodiments, the messaging platform 105 may be configured to perform certain operations to implement the Undo Send feature.

For example, the client device 104 may send the undoable message to the messaging platform when a message send operation is performed in a message compose screen. In this case, the messaging platform may be responsible for delaying the actual sending of an undoable message. By way of example and without limitation, this can be accomplished by backing the sent message with a “Kafka” topic and delaying the read of that topic by a stratostreaming consumer. Kafka refers to a distributed streaming platform which allows creation of data streaming pipelines. While an example embodiment uses Kafka queuing, the technology described herein is not limited in this respect and any scheduled queueing mechanism or semantic may be used. In this example embodiment, the client device can post to a new endpoint. This endpoint has an undo timer parameter and may be called when a user with a valid and enabled Undo Send feature performs a message send operation for an undoable message. A message ID may be added to a discard cache if the user taps undo during the undo period. If the user takes no action, the message platform is responsible for sending out the message.

FIG. 6 is a diagram illustrating a non-limiting example of an Undo Send data flow in which the messaging platform 105 performs certain operations.

A user composes message in a client message composer 601. This message may include, but is not limited to, one or more of text, graphics, images, uniform resource locators, video, audio, multimedia, or the like. At ST 1, the user selects to send the composed message by, for example, selecting a Send Message button displayed in the message composer 601 (such as button 434 in FIG. 4B). At ST 2, the message is added to an undoable messages store 603. At ST 3, the message is sent to a backend queue 605 and, at ST 4, the message is written to one of a plurality of a Kafka topics 607a, 607b or 607c, each associated with a respective undo period (e.g., 30 seconds, 20 seconds, 10 seconds). In an example embodiment, the message from the user device may include information about the undo period associated with the message and this information is used to identify the topic (or scheduled queue) to which the message is written. As noted above, the undo period for a particular message may be set by the user (e.g., via a user setting) and, in an example, embodiment, a topic or scheduled queue may be provided for each undo period settable by users in the messaging system. As noted, while Kafka topics are used in an example embodiment, any scheduled queuing mechanism or semantic may be used. At ST 5, the message is read from the Kapka topic by a read operation 609 and, at ST 6, is written to a message column 611 for posting delaying messages. At ST 7, a discard cache 613 is checked to determine whether the cache includes a message identifier corresponding to the message. If the identifier is contained in the discard cache 613 (indicating that the sending of the message has been undone), the message is discarded. If the identifier is not contained in the discard cache 613, the message is posted at ST 8 to a distribution module 615. At ST 9, the distribution module provides notification to message column 611 regarding the success/failure of the posting of the message. A successfully sent message is stored in a sent message cache 617 at ST 10 and the client device 104 is notified at ST 11 of the success/failure of posting the message.

ST 2a through ST 2g are performed if the user selects Undo Send during the undo time period. In particular, if the user selects Undo Send at ST 2a from an Undo Send entry point 619, the undoable message is retrieved from the undoable message store 603 at ST 2b and presented to the user in the message composer 601 at ST 2c. If the message has been sent to the backend queue 605, an undo send notification including an identifier of the message is sent to an undo send column 621 of the backend at ST 2d. At ST 2e, the sent message cache 617 is checked to determine whether the message has already been sent and, at ST 2f, an indication of the success/failure of the undo is returned to the client device 104. At ST 2g, the message identifier is added to the discard cache for use in the checking conducted at ST 7.

In the case of the message not having been sent by the messaging platform, the user can, for example, revise the undoable message in the message composer 601 and, when the revision is complete, send the message to messaging platform.

A benefit of the example embodiment of FIG. 6 is that a user can safely close the messaging application on the client device while the undo timer is running and the message will nonetheless still get sent because the message is sent to the backend as described. The relationship between the client and the backend in the FIG. 6 embodiment makes the backend the “source of truth” for sending messages.

The FIG. 6 embodiment also allows for easy reproduction of undone drafts by keeping a local copy of an undoable message on the client and ensures that a message will always be sent in case a user completely closes out of the app or the app is terminated through another process (e.g., application crash) because the backend queue is responsible for sending out the tweet after timer completion, not the client.

In the case that a message posts at ST 8, the client can be informed and a message that failed to post can still be available to the user in the message store 603.

In another scenario, in a case in which the user attaches media or some other type of attachment that takes more time to upload than is on the timer, the status would still be waiting for outbox operations to complete and a user can cancel the message upload by removing the message from the outbox.

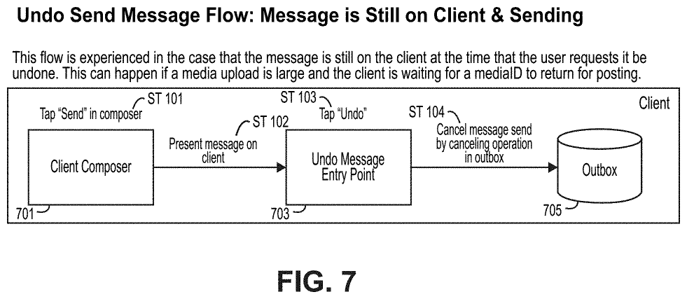

FIG. 7 illustrates an example data flow in the case in which the message is still on the client at the time the user selects the Undo Send button. This situation can arise, for example, if the media upload is large and the client is still waiting for an identifier to return for posting. In ST 101, the user selects “send” in the client message composer 701 and the message is presented to the client for processing at ST 102. If the user selects Undo Send at ST 103 from an Undo Send Entry point 703 while the message is still on the client, the sending of the message is canceled at ST 104 by canceling the operation in the outbox 705.

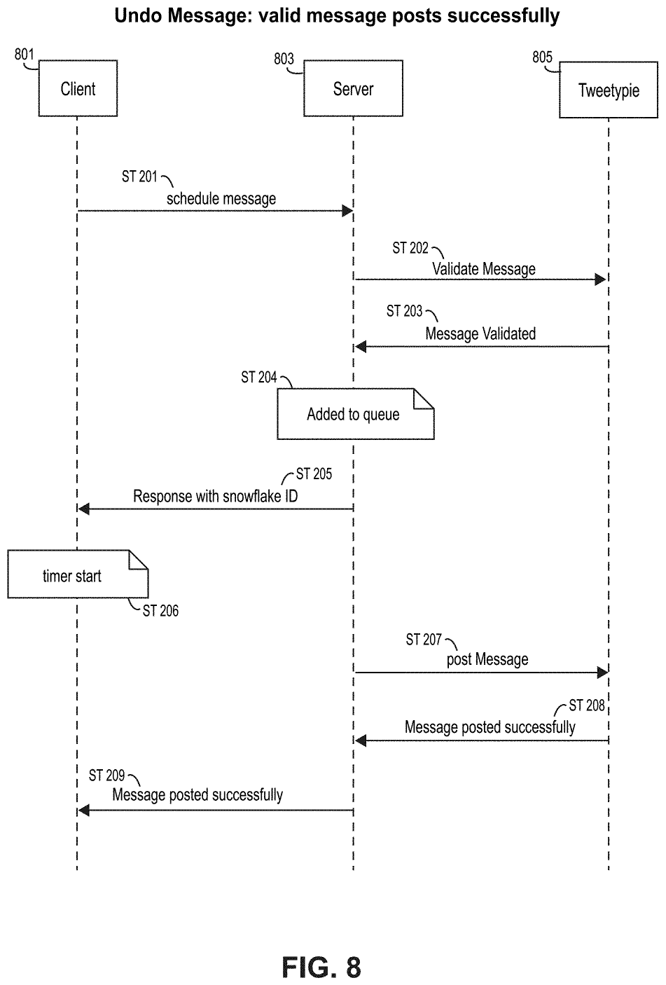

FIG. 8 is a sequence diagram for an example scenario in which the user posts an undoable message, and decides not to undo so that the message posts after the undo timer expires. A client 801 sends a message to server 803 at ST 201 and the server validates the message with message distribution module 805 at ST 202 and ST 203. If the message is validated, the server 803 adds the message to the queue at ST 204 and provides a message identifier to the client 801 at ST 205. In one example embodiment, this identifier may be a so-called Snowflake ID including a timestamp, a machine ID, and a sequence number. Of course, other identifiers may be used and the systems and methods described herein are not limited in this respect.

Client 801 begins the timer at ST 206 and, as noted above, because the user does not initiate the Undo Send processing, the server 803 posts the message to message distribution module 805 at ST 207. The message distribution module 805 notifies the server 803 at ST 208 of the successful posting of the message and the server 803 notifies the client 801 of the successful posting of the message at ST 209.

In various example embodiments, client 801 may correspond to a user device 104 and server 803 and message distribution module 805 may correspond to a server(s) and/or a module(s) of the messaging platform 105.

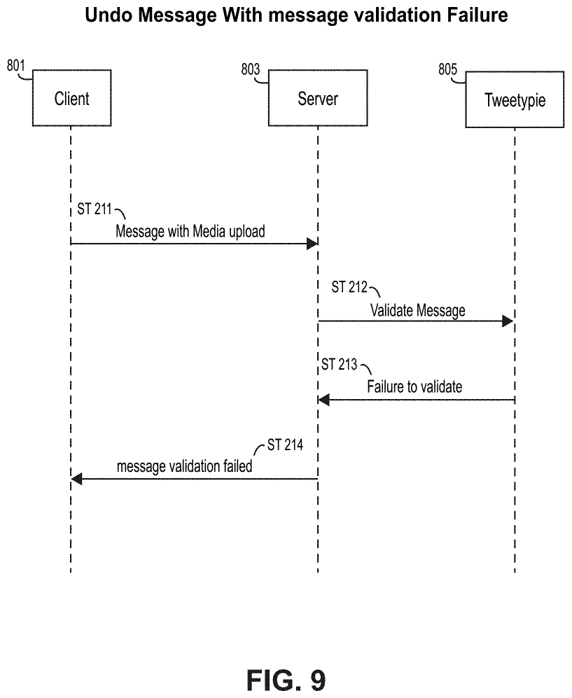

FIG. 9 is an example sequence diagram for an Undo Send scenario in which message validation fails. At ST 211, a message with media is uploaded from client 801 to server 803. The server 803 presents the message to message distribution module 805 for validation at ST 212 and the message distribution module 805 fails to validate the message at ST 213 and the server 803 notifies the client 801 of the message validation failure at ST 214. The Undo Send timer never starts on either the client 801 or the server 803 because the message was not validated.

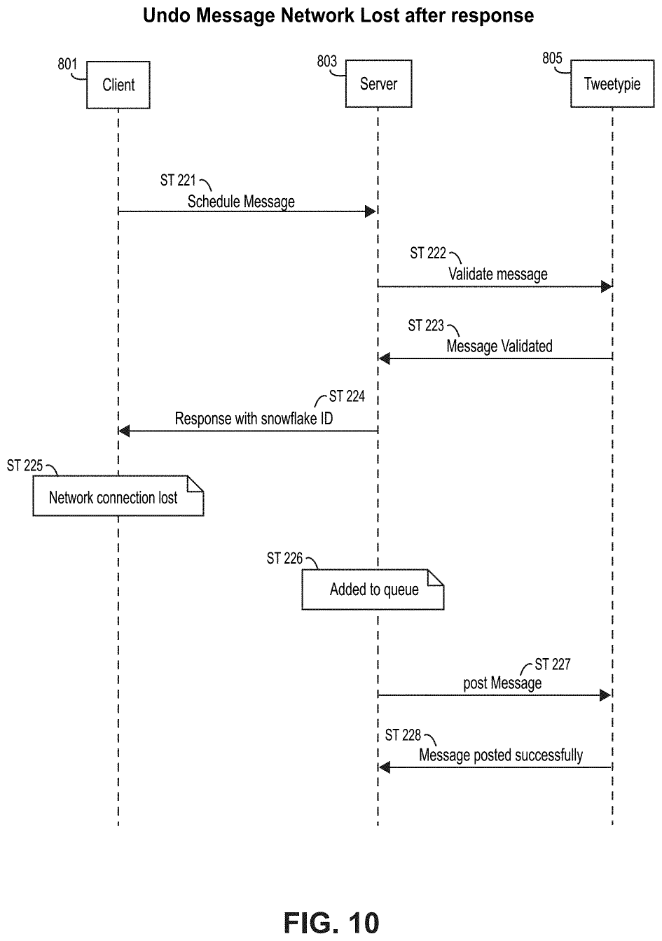

FIG. 10 is a sequence diagram for an example Undo Send scenario in which the network connection between the client 801 and the server 803 is lost. The client 801 sends a message to server 803 at ST 221 and the server validates the message with message distribution module 805 at ST 222 and ST 223. If the message is validated, the server 803 provides a message identifier to the client 801 at ST 224. If the network connection is lost at ST 225, the message is nonetheless added to the queue at ST 226 and the server 803 posts the message to message distribution module 805 at ST 227. The message distribution module 805 notifies the server 803 at ST 228 of the successful posting of the message.

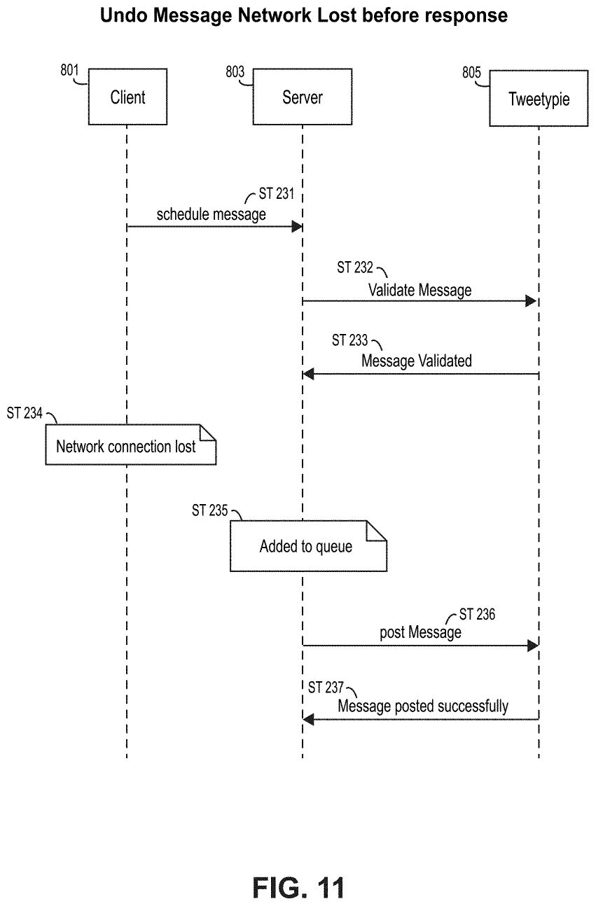

FIG. 11 is a sequence diagram for an example Undo Send scenario in which the network connection between the client 801 and the server 803 is lost before the message identifier is returned to the client 801. The client 801 sends a message to server 803 at ST 231 and the server validates the message with message distribution module 805 at ST 232 and ST 233. The network connection between the client 801 and the server 803 is lost at ST 234 before any message identifier is returned to the client. The message is nonetheless added to the queue at ST 235 and the server 803 posts the message to message distribution module 805 at ST 236. The message distribution module 805 notifies the server 803 at ST 237 of the successful posting of the message.

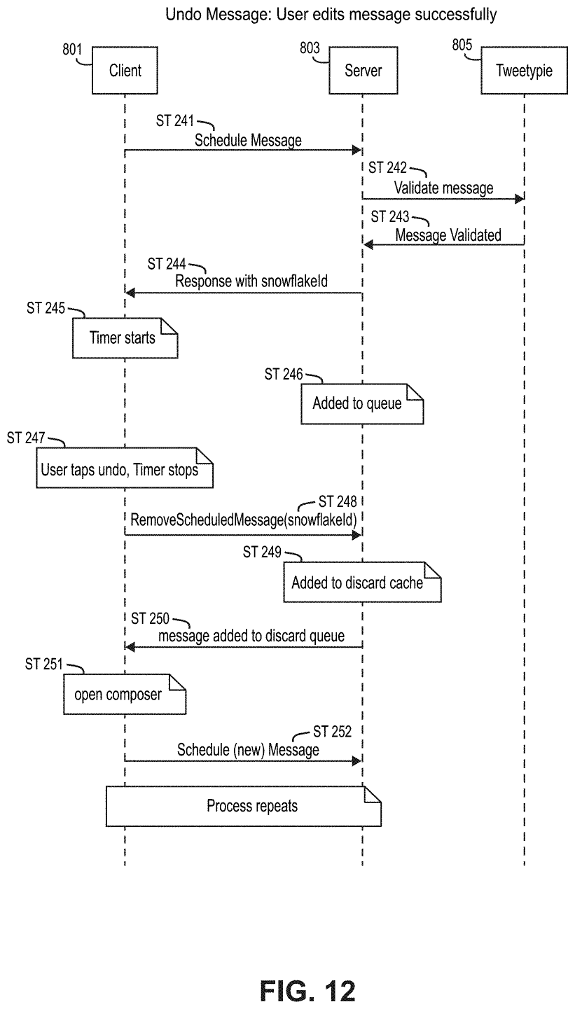

FIG. 12 is a sequence diagram for an example Undo Send scenario in which a user successfully undoes sending of a message. The client 801 sends a message to server 803 at ST 241 and the server validates the message with message distribution module 805 at ST 242 and ST 243. If the message is validated, the server 803 provides a message identifier to the client 801 at ST 244. Client 801 begins the timer at ST 245 and the server adds the message to queue at ST 246. At St 247, the user taps Undo Send and the timer is stopped. The client 801 sends remove message indication to the server 803 at ST 248 and the message identifier is added to a discard cache at ST 249. At ST 250, the server 803 sends an indication to the client 801 that the message is added to the discard cache and the client opens the message composer for undoing the sending of the message at ST 251. At ST 252, the client 801 sends the edited (revised) message to the server 803 and the process of ST 242, ST 243, etc. can be performed again.

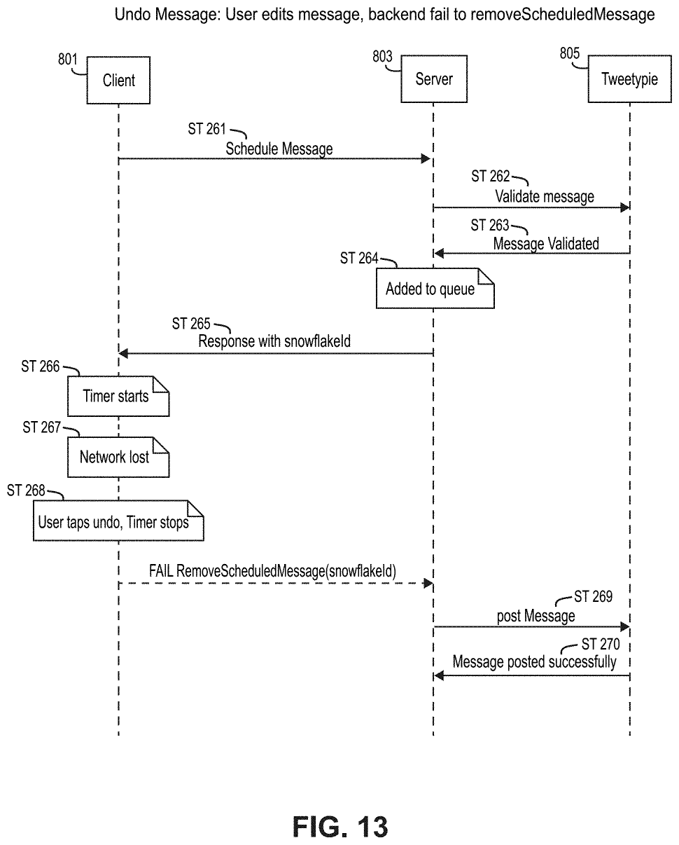

FIG. 13 is a sequence diagram for an example Undo Send scenario in which an undo send operation is unsuccessful because of a lost network connection. The client 801 sends a message to server 803 at ST 261 and the server validates the message with message distribution module 805 at ST 262 and ST 263. If the message is validated, the server 803 adds the message to queue at ST 264 and provides a message identifier to the client 801 at ST 265. Client 801 begins the timer at ST 266. At ST 247, the network connection is lost. At ST 268, the user taps Undo Send and the timer is stopped. However, no remove message indication is sent to the server because there is no network connection. Thus, the server posts the message at ST 269 and an indication of the successful posting of the message is provided to the server 803 at ST 270.

One consideration regarding Undo Send operations is the involvement of the messaging platform in maintaining the state of an unsent draft. The involvement of messaging platform can create complexities of synchronizing the client and the messaging platform.

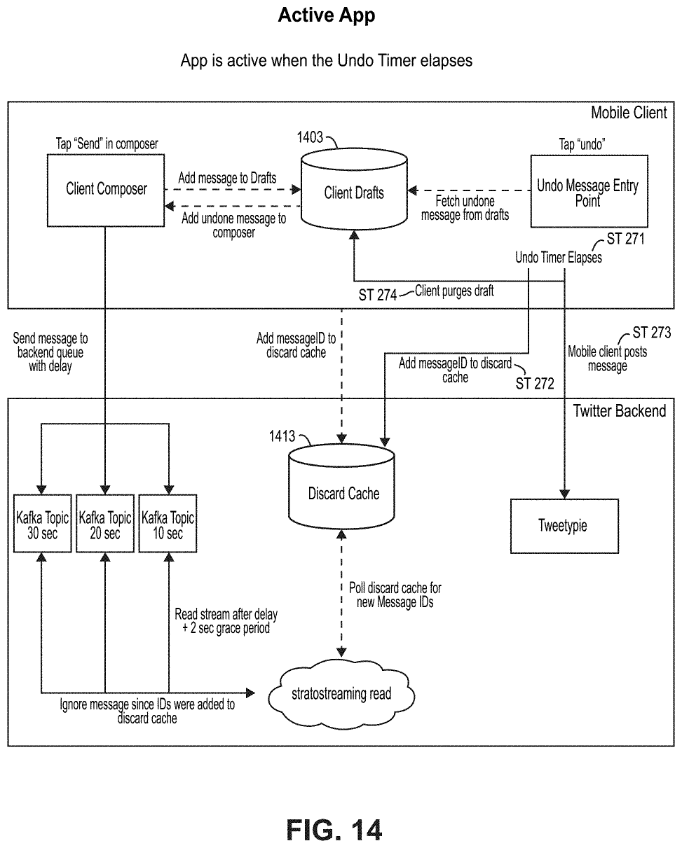

FIG. 14 illustrates an example process flow in which, if a user undoes sending of a message, the message identifier gets added to the discard cache which is polled in order to fetch identifiers of messages that should not be sent out after the time has elapsed. If a user does not undo a send and the messaging application is active when the timer expires, the message identifier can also be added to the discard cache, thereby making the client device responsible for sending out the message. In this case, the client proceeds through a standard message send process. In particular, in FIG. 14, at ST 271, the undo timer expires. The client then sends the message identifier to the messaging platform at ST 272, where the identifier is added to the discard cache 1413. At ST 273, the client device posts the message for distribution and at ST 275, the message is purged from the drafts store 1403. Because the identifier of the message was added to the discard cache, the messaging platform does not send the original message.

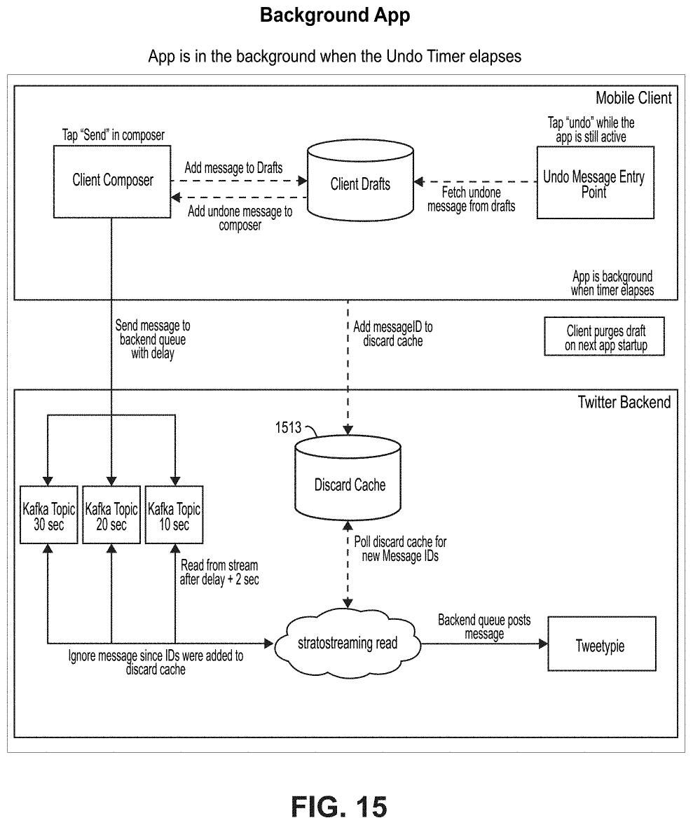

FIG. 15 illustrates an example process flow when the messaging application is in the background when the undo timer expires. In this case, if the user undoes sending of the message before the application is backgrounded, the message identifier gets added to the discard cache 1513 and will not be sent out. If the user does not undo sending of the message before the application is backgrounded, no message identifier is added to the discard cache and the message is then sent out by the messaging platform.

In accordance with a non-limiting example embodiment of the disclosure, an electronic device includes a display; a communication circuit; a memory storing one or instructions; and a processor for executing the one or more instructions to configure the processor to control the electronic device to: display, on the display, a message compose screen; receive message compose inputs to the message compose screen for composing a message; receive a message send input for sending the message via the communication circuit; set a timer; and send the message, via the communication circuit, after expiration of the timer.

In accordance with the electronic device of the immediately preceding paragraph, the timer is set based on a characteristic of the message.

In accordance with the electronic device of any of the preceding two paragraphs, the characteristic of the message comprises content of the message, whereby the timer is set to a first timer value based on first message content and to a second timer value different from the first timer value based on second message content different from the first message content.

In accordance with the electronic device of any of the preceding three paragraphs, the characteristic of the message comprises a recipient of the message, whereby the timer is set to a first timer value based on a first message recipient and to a second timer value different from the first time value based a second message recipient different from the first message recipient.

In accordance with the electronic device of any of the preceding four paragraphs, the characteristic of the message comprises a time for composing the message, whereby the timer is set to a first timer value based on a first time for composing the message and to a second timer value different from the first time value based a second time for composing the message different from the first time.

In accordance with the electronic device of any of the preceding five paragraphs, the characteristic of the message comprises a frequency of sending of messages to a receipt of the message, whereby the timer is set to a first timer value based on a first sending frequency and to a second timer value different from the first time value based a second sending frequency different from the first sending frequency.

In accordance with the electronic device of any of the preceding six paragraphs, the processor is further configured to control the electronic device to, based on receiving an undo send input before expiration of the timer, display, on the display, the message; and receive edit inputs for editing the message before sending.

In accordance with the electronic device of any of the preceding seven paragraphs, the processor is further configured to control the electronic device to locally inject the message for which the send input is received into a message timeline obtained from an external electronic device.

A non-limiting example method for an electronic device comprises: displaying, on a display of the electronic device, a message compose screen; receiving message compose inputs to the message compose screen for composing a message; receiving a message send input for sending the message via a communication circuit of the electronic device; setting a timer; and sending the message, via the communication circuit, after expiration of the timer.

In accordance with the method of the immediately preceding paragraph, the timer is set based on a characteristic of the message.

In accordance with the method of any of the preceding two paragraphs, the method further comprises, based on receiving an undo send input before expiration of the timer, displaying, on the display, the message; and receiving edit inputs for editing the message before sending.

In accordance with the method of any of the preceding three paragraphs, the method further comprises locally injecting the message for which the send input is received into a message timeline obtained from an external electronic device.

A non-limiting example non-transitory computer readable storage medium stores one or more instructions which, when executed by a processor of an electronic device, configure the processor to control the electronic device to: display, on a display of the electronic device, a message compose screen; receive message compose inputs to the message compose screen for composing a message; receive a message send input for sending the message via a communication circuit of the electronic device; set a timer; and send the message, via the communication circuit, after expiration of the timer.

In accordance with the non-transitory computer readable storage medium of the immediately preceding paragraph, the one or more instructions, when executed by a processor of an electronic device, configure the processor to control the electronic device to set the timer based on a characteristic of the message.

In accordance with the non-transitory computer readable storage medium of any of the preceding two paragraphs, the one or more instructions, when executed by a processor of an electronic device, configure the processor to control the electronic device to: based on receiving an undo send input before expiration of the timer, display, on the display, the message; and receive edit inputs for editing the message before sending.

In accordance with the non-transitory computer readable storage medium of any of the preceding three paragraphs, the one or more instructions, when executed by a processor of an electronic device, configure the processor to control the electronic device to locally inject the message for which the send input is received into a message timeline obtained from an external electronic device.

A non-limiting, example electronic device comprises a non-transitory computer-readable storage medium of any of the preceding four paragraphs; and a processor.

A non-limiting example electronic device comprises a communication circuit; a memory storing one or more instructions; and a processor for executing the one or more instructions to configure the processor to control the electronic device to: receive a message, via the communication circuit, from an external electronic device; store the received message in a message store for forwarding to one or more recipients; based on receiving an indication of further processing of the message from the external electronic device within a specified time period, discard the message without sending to the one or more recipients; and based on not receiving an indication of further processing of the message from the external electronic device within the specified time period, send the message to the one or more recipients.

In accordance with the electronic device of the immediately preceding paragraph, the further processing of the message comprises editing of the message.

A non-limiting example method for an electronic device comprises receiving a message, via a communication circuit of the electronic device, from an external electronic device; storing the received message in a message store for forwarding to one or more recipients; based on receiving an indication of further processing of the message from the external electronic device within a specified time period, discarding the message without sending to the one or more recipients; and, based on not receiving an indication of further processing of the message from the external electronic device within the specified time period, sending the message to the one or more recipients.

In accordance with the electronic device of the immediately preceding paragraph, the further processing of the message comprises editing of the message.

A non-limiting, example non-transitory computer readable storage medium stores one or more instructions which, when executed by a processor of an electronic device, configure the processor to control the electronic device to: receive a message, via a communication circuit of the electronic device, from an external electronic device; store the received message in a message store for forwarding to one or more recipients; based on receiving an indication of further processing of the message from the external electronic device within a specified time period, discard the message without sending to the one or more recipients; and based on not receiving an indication of further processing of the message from the external electronic device within the specified time period, send the message to the one or more recipients.

In accordance with the non-transitory computer readable storage medium of the immediately preceding paragraph, the further processing of the message comprises editing of the message.

A non-limiting example electronic device comprises a non-transitory computer readable storage medium according to any of the two preceding paragraphs; and a processor.

A non-limiting, example electronic device comprises a display; a communication circuit; a memory storing one or instructions; and a processor for executing the one or more instructions to configure the processor to control the electronic device to: display, on the display, a message compose screen; receive message compose inputs to the message compose screen for composing a message; receive a message send input for sending the message via the communication circuit; based on the message being a first message type, set a message send timer based on a characteristic of the message and send the message, via the communication circuit, after expiration of the message send timer; and based on the message being a second message type different from the first message type, send the message, via the communication circuit, without setting the message send timer.

Various embodiments of this disclosure may be implemented as software (e.g., programs) including one or more instructions that are stored in a storage medium readable by a machine (e.g., a computer, a processor, or the like). For example, a processor of a machine may invoke at least one of the one or more instructions stored in the storage medium to execute it. This allows the machine to be operated to perform at least one function according to the invoked at least one instruction. The one or more instructions may include a code generated by a complier or a code executable by an interpreter. The machine-readable storage medium may be provided in the form of a non-transitory storage medium. A “non-transitory” storage medium is a tangible device and may not include a signal (e.g., electromagnetic wave), but this term does not distinguish whether data is stored semi-permanently or temporarily in the storage medium.

According to an embodiment, a method according to various embodiments disclosed in this document may be provided by being included in a computer program product. The computer program product may be traded as a commodity between a seller and a purchaser. A computer program product may be distributed in the form of a machine-readable storage medium (e.g., compact disc read only memory (CD-ROM)) or be distributed online (e.g., download or upload) directly between two user devices (e.g. smartphones) through an application store. For on-line distribution, at least a portion of the computer program product may be temporarily stored or temporarily created in a machine readable storage medium such as a memory of a manufacturer's server, an application store's server, or a relay server.

According to various embodiments, each component (e.g., module or program) of the above-described components may include a single entity or multiple entities, and some of the multiple entities may be separately arranged on other components. According to various embodiments, one or more components or operations may be omitted from the above-described components, or one or more other components or operations may be added. Alternatively or additionally, a plurality of components (e.g., modules or programs) may be integrated into a single component. In this case, the integrated component may perform one or more functions of each of the plurality of components in the same or similar manner as they are performed by a corresponding one of the plurality of components before the integration. According to various embodiments, operations performed by a module, a program, or another component may be carried out in sequence, in parallel, by repetition, or heuristically, or one or more of the operations may be executed in a different order or may be omitted, and one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a display;
a communication circuit;
a memory storing one or instructions; and
a processor for executing the one or more instructions to configure the processor to control the electronic device to:
display, on the display, a message compose screen;
receive message compose inputs to the message compose screen for composing a message;
receive a message send input for sending the message via the communication circuit;
set a timer; and
send the message, via the communication circuit, after expiration of the timer.

2. The electronic device of claim 1, wherein the time is set based on a characteristic of the message.

3. The electronic device of claim 2, wherein the characteristic of the message comprises content of the message, whereby the timer is set to a first timer value based on first message content and to a second timer value different from the first timer value based on second message content different from the first message content.

4. The electronic device of claim 2, wherein the characteristic of the message comprises a recipient of the message, whereby the timer is set to a first timer value based on a first message recipient and to a second timer value different from the first time value based a second message recipient different from the first message recipient.

5. The electronic device of claim 2, wherein the characteristic of the message comprises a time for composing the message, whereby the timer is set to a first timer value based on a first time for composing the message and to a second timer value different from the first time value based a second time for composing the message different from the first time.

6. The electronic device of claim 2, wherein the characteristic of the message comprises a frequency of sending of messages to a receipt of the message, whereby the timer is set to a first timer value based on a first sending frequency and to a second timer value different from the first time value based a second sending frequency different from the first sending frequency.

7. The electronic device of claim 1, wherein the processor is further configured to control the electronic device to:
based on receiving an undo send input before expiration of the timer, display, on the display, the message; and
receive edit inputs for editing the message before sending.

8. The electronic device of claim 7, wherein the processor is further configured to control the electronic device to:
locally inject the message for which the send input is received into a message timeline obtained from an external electronic device.

9. A method for an electronic device, the method comprising:
displaying, on a display of the electronic device, a message compose screen;
receiving message compose inputs to the message compose screen for composing a message;
receiving a message send input for sending the message via a communication circuit of the electronic device;
setting a timer; and
sending the message, via the communication circuit, after expiration of the timer.

10. The method of claim 9, wherein the timer is set based on a characteristic of the message.

11. The method of claim 9, further comprising:
based on receiving an undo send input before expiration of the timer, displaying, on the display, the message; and
receiving edit inputs for editing the message before sending.

12. The method of claim 9, further comprising:
locally injecting the message for which the send input is received into a message timeline obtained from an external electronic device.

13. A non-transitory computer readable storage medium storing one or more instructions which, when executed by a processor of an electronic device, configure the processor to control the electronic device to:
display, on a display of the electronic device, a message compose screen;
receive message compose inputs to the message compose screen for composing a message;
receive a message send input for sending the message via a communication circuit of the electronic device;
set a timer; and
send the message, via the communication circuit, after expiration of the timer.

14. The non-transitory computer readable storage medium according to claim 13, wherein the one or more instructions, when executed by a processor of an electronic device, configure the processor to control the electronic device to set the timer based on a characteristic of the message.

15. The non-transitory computer readable storage medium according to claim 13, wherein the one or more instructions, when executed by a processor of an electronic device, configure the processor to control the electronic device to:
based on receiving an undo send input before expiration of the timer, display, on the display, the message; and
receive edit inputs for editing the message before sending.

16. The non-transitory computer readable storage medium according to claim 13, wherein the one or more instructions, when executed by a processor of an electronic device, configure the processor to control the electronic device to locally inject the message for which the send input is received into a message timeline obtained from an external electronic device.

17. An electronic device comprising:
a non-transitory computer-readable storage medium of claim 13; and
a processor.

18. An electronic device comprising:
a communication circuit;
a memory storing one or more instructions; and
a processor for executing the one or more instructions to configure the processor to control the electronic device to:
receive a message, via the communication circuit, from an external electronic device;
store the received message in a message store for forwarding to one or more recipients;
based on receiving an indication of further processing of the message from the external electronic device within a specified time period, discard the message without sending to the one or more recipients; and
based on not receiving an indication of further processing of the message from the external electronic device within the specified time period, send the message to the one or more recipients.

19. The electronic device of claim 18, wherein the further processing of the message comprises editing of the message.

20. A method for an electronic device, the method comprising:
receiving a message, via a communication circuit of the electronic device, from an external electronic device;
storing the received message in a message store for forwarding to one or more recipients;
based on receiving an indication of further processing of the message from the external electronic device within a specified time period, discarding the message without sending to the one or more recipients; and
based on not receiving an indication of further processing of the message from the external electronic device within the specified time period, sending the message to the one or more recipients.

21. The method of claim 20, wherein the further processing of the message comprises editing of the message.

22. A non-transitory computer readable storage medium storing one or more instructions which, when executed by a processor of an electronic device, configure the processor to control the electronic device to:
receive a message, via a communication circuit of the electronic device, from an external electronic device;
store the received message in a message store for forwarding to one or more recipients;
based on receiving an indication of further processing of the message from the external electronic device within a specified time period, discard the message without sending to the one or more recipients; and
based on not receiving an indication of further processing of the message from the external electronic device within the specified time period, send the message to the one or more recipients.

23. The non-transitory computer readable storage medium of claim 22, wherein the further processing of the message comprises editing of the message.

24. An electronic device comprising:
a non-transitory computer readable storage medium of claim 22; and
a processor.

25. An electronic device comprising:
a display;
a communication circuit;
a memory storing one or instructions; and
a processor for executing the one or more instructions to configure the processor to control the electronic device to:
display, on the display, a message compose screen;
receive message compose inputs to the message compose screen for composing a message;
receive a message send input for sending the message via the communication circuit;
based on the message being a first message type, set a message send timer based on a characteristic of the message and send the message, via the communication circuit, after expiration of the message send timer; and
based on the message being a second message type different from the first message type, send the message, via the communication circuit, without setting the message send timer.
